(19) United States
(12) Patent Application Publication
(10) Pub. No.: US 2025/0343945 A1
(43) Pub. Date: Nov. 6, 2025

(54) Methods and Apparatus of Improvement for Intra Mode Derivation and Prediction Using Gradient and Template

(71) Applicant: MEDIATEK INC., Hsinchu City (TW)

(72) Inventors: Chia-Ming TSAI, Hsinchu City (TW); Chun-Chia CHEN, Hsinchu City (TW); Man-Shu CHIANG, Hsinchu City (TW); Cheng-Yen CHUANG, Hsinchu City (TW); Yu-Cheng LIN, Hsinchu City (TW); Tzu-Der CHUANG, Hsinchu City (TW); Chih-Wei HSU, Hsinchu City (TW); Ching-Yeh CHEN, Hsinchu City (TW); Yu-Wen HUANG, Hsinchu City (TW)

(21) Appl. No.: 18/855,484

(22) PCT Filed: Mar. 22, 2023
(86) PCT No.: PCT/CN2023/083014

§ 371 Date: Oct. 9, 2024

Related U.S. Application Data
(60) Provisional application No. 63/331,351, filed on Apr. 15, 2022.

(51) Int. Cl. H04N 19/593; H04N 19/11; H04N 19/176; H04N 19/196; H04N 19/70

(52) U.S. Cl. CPC H04N 19/593; H04N 19/11; H04N 19/176; H04N 19/196; H04N 19/70

(57) ABSTRACT

Methods and apparatus for video coding. When a current intra angular prediction mode for the current block is not in the MPM list, a mode syntax related to a current intra prediction mode for the current block is signalled or parsed depending on first information derived according to DIMD or TIMD. A final intra predictor is generated based on second information comprising the first information and the mode syntax. The current block is encoded or decoded using a final mode derived based on information comprising the syntax.

### CROSS REFERENCE TO RELATED APPLICATIONS

The present invention is a non-Provisional Application of and claims priority to U.S. Provisional Patent Application No. 63/331,351, filed on Apr. 15, 2022. The U.S. Provisional Patent Application is hereby incorporated by reference in its entirety.

### FIELD OF THE INVENTION

The present invention relates to intra prediction in a video coding system. In particular, the present invention relates to bit saving for intra prediction mode using DIMD (Decoder Side Intra Mode Derivation) or TIMD (Template-based Intra Mode Derivation).

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In the multi-type tree structure, a first flag (mtt_split_cu_flag) is signalled to indicate whether the node is further partitioned; when a node is further partitioned, a second flag (mtt_split_cu_vertical_flag) is signalled to indicate the splitting direction, and then a third flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derviation based on multi-type tree syntax elements

| | mtt_split_cu_ver- | mtt_split_cu_bi- |
|---|---|---|
| MttSplitMode | tical_flag | nary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined and specified by SPS syntax elements for the quadtree with nested multi-type tree coding tree scheme.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinBtSize: the minimum allowed binary tree leaf node size
MinTtSize: the minimum allowed ternary tree leaf node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinBtSize and Min TtSize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinBtSize and smaller or equal to 2*MinTtSize, no further horizontal splitting is considered. Similarly, when the multi-type tree node has height equal to MinBtSize and smaller or equal to 2*MinTtSize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

In order to keep the VPDU size as 64×64 luma samples, the following normative partition restrictions (with syntax signalling modification) are applied in VTM, as shown in FIG. 5:
TT split is not allowed (as indicated by “X” in FIG. 5) for a CU with either width or height, or both width and height equal to 128.
For a 128×N CU with N≤64 (i.e. width equal to 128 and height smaller than 128), horizontal BT is not allowed.

For an N×128 CU with N≤64 (i.e. height equal to 128 and width smaller than 128), vertical BT is not allowed. In FIG. 5, the luma block size is 128×128. The dashed lines indicate block size 64×64. According to the constraints mentioned above, examples of the partitions not allowed are indicated by “X” as shown in various examples (510-580) in FIG. 5.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as dotted arrows in FIG. 6, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:
   MPM list→{Planar, DC, V, H, V—4, V+4}
If one of modes Left and Above is angular mode, and the other is non-angular:
   Set a mode Max as the larger mode in Left and Above
   MPM list→{Planar, Max, DC, Max—1, Max+1, Max—2}
If Left and Above are both angular and they are different:
   Set a mode Max as the larger mode in Left and Above
   if the difference of mode Left and Above is in the range of 2 to 62, inclusive
      MPM list→{Planar, Left, Above, DC, Max—1, Max+1}
   Otherwise
      MPM list→{Planar, Left, Above, DC, Max—2, Max+2}
   If Left and Above are both angular and they are the same:
      MPM list→{Planar, Left, Left—1, Left+1, DC, Left—2}

Besides, the first bin of the MPM index codeword is CABAC context coded. In total three contexts are used, corresponding to whether the current intra block is MRL enabled, ISP enabled, or a normal intra block.

During the 6 MPM list generation process, pruning is used to remove duplicated modes so that only unique modes can be included into the MPM list. For entropy coding of the 61 non-MPM modes, a Truncated Binary Code (TBC) is used.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

To support these prediction directions, the top reference with length 2W+1, and the left reference with length 2H+1, are defined as shown in FIG. 7A and FIG. 7B respectively.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Decoder Side Intra Mode Derivation (DIMD)

When DIMD is applied, two intra modes are derived from the reconstructed neighbour samples, and those two predictors are combined with the planar mode predictor with the weights derived from the gradients. The DIMD mode is used as an alternative prediction mode and is always checked in the high-complexity RDO (Rate-Distortion Optimization) mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, centered on the pixels of the middle line of the template. At each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 2 )$$

FIGS. 8A-C show an example of HoG, calculated after applying the above operations on all pixel positions in the template. FIG. 8A illustrates an example of selected template 820 for a current block 810. Template 820 comprises T lines above the current block and T columns to the left of the current block. For intra prediction of the current block, the area 830 at the above and left of the current block corresponds to a reconstructed area and the area 840 below and at the right of the block corresponds to an unavailable area. FIG. 8B illustrates an example for T=3 and the HoGs are calculated for pixels 860 in the middle line and pixels 862 in the middle column. For example, for pixel 852, a 3×3 window 850 is used. FIG. 8C illustrates an example of the amplitudes (amp) calculated based on equation (2) for the angular intra prediction modes as determined from equation (1).

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 9 illustrates an example of the blending process. As shown in FIG. 9, two intra modes (M1 912 and M2 914) are selected according to the indices with two tallest bars of histogram bars 910. The three predictors (940, 942 and 944) are used to form the blended prediction. The three predictors correspond to applying the M1, M2 and planar intra modes (920, 922 and 924 respectively) to the reference pixels 930 to form the respective predictors. The three predictors are weighted by respective weighting factors (ω₁, ω₂ and ω₃) 950. The weighted predictors are summed using adder 952 to generated the blended predictor 960.

Besides, the two implicitly derived intra modes are included into the MPM list so that the DIMD process is performed before the MPM list is constructed. The primary derived intra mode of a DIMD block is stored with a block and is used for MPM list construction of the neighbouring blocks.

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 10, the prediction samples of the template (1012 and 1014) for the current block 1010 are generated using the reference samples (1020 and 1022) of the template for each candidate mode. A cost is calculated as the SATD (Sum of Absolute Transformed Differences) between the prediction samples and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used. Weights of the modes are computed from their SATD costs as follows:

$$weight 1 = costMode 2 / ( costMode 1 + costMode 2 ) \\ weight 2 = 1 - weight 1.$$

In the present invention, method and apparatus are disclosed to further reduce data related to intra prediction.

### BRIEF SUMMARY OF THE INVENTION

A method and apparatus for video coding are disclosed. According to the method, pixel data associated with a current block at an encoder side or coded data associated with the current block to be decoded at a decoder side are received. When a current intra angular prediction mode for the current block is not in a probable mode set, a mode syntax related to a current intra prediction mode for the current block is signalled or parsed depending on first information derived according to DIMD (Decoder Side Intra Mode Derivation) or TIMD (Template-based Intra Mode Derivation), wherein the probable mode set comprises candidate modes in an MPM (Most Probable Modes) list. A final intra predictor is generated based on second information comprising the first information and the mode syntax.

In one embodiment, all intra angular prediction modes are divided into a plurality of groups and the first information corresponds to a target group determined for the current block based on the DIMD or the TIMD. In another embodiment, the mode syntax is related to indicating the current intra angular prediction mode within the target group.

In one embodiment, the probable mode set comprises the candidate modes in the MPM list a precise intra prediction mode derived using an implicit coding tool other than the DIMD and the TIMD, or a combination thereof.

According to another method of the present invention, an initial MPM (Most Probable Modes) list is determined for the current block. One or more DIMD (Decoder Side Intra Mode Derivation) candidate modes are generated using a template of the current block. One or more neighbouring intra prediction modes associated with one or more neighbouring blocks of the current block are determined. A final MPM list is generated by adding one or more additional candidate modes to the initial MPM list, wherein said one or more additional candidate modes comprise said one or more DIMD candidate modes. The current block is encoded or decoded using information comprising the final MPM list.

In one embodiment, said one or more additional candidate modes comprise said one or more DIMD candidate modes, said one or more neighbouring intra prediction modes, one or more derived modes of said one or more DIMD candidate modes, one or more derived modes of said one or more neighbouring intra prediction modes, or a combination thereof. In one embodiment, said one or more derived modes of said one or more DIMD candidate modes comprise a mode number corresponding to (one DIMD candidate mode+k), wherein the k is a non-zero integer. In one embodiment, said one or more derived modes of said one or more neighbouring intra prediction modes comprise a mode number corresponding to (one neighbouring intra prediction mode+k), wherein the k is a non-zero integer.

In one embodiment, said one or more neighbouring intra prediction modes comprise an above neighbouring intra prediction mode of an above neighbouring block, a top neighbouring intra prediction mode of a top neighbouring block, or both. In another embodiment, said one or more derived modes of said one or more DIMD candidate modes are including in the final MPM list after said one or more derived modes of said one or more neighbouring intra prediction modes or after said one or more neighbouring intra prediction modes.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 shows some examples of TT split forbidden when either width or height of a luma coding block is larger than 64.

FIG. 6 shows the intra prediction modes as adopted by the VVC video coding standard.

FIGS. 7A-B illustrate examples of wide-angle intra prediction a block with width larger than height (FIG. 7A) and a block with height larger than width (FIG. 7B).

FIG. 8A illustrates an example of selected template for a current block, where the template comprises T lines above the current block and T columns to the left of the current block.

FIG. 8B illustrates an example for T=3 and the HoGs (Histogram of Gradient) are calculated for pixels in the middle line and pixels in the middle column.

FIG. 8C illustrates an example of the amplitudes (amp) for the angular intra prediction modes.

FIG. 9 illustrates an example of the blending process, where two intra modes (M1 and M2) and the planar mode are selected according to the indices with two tallest bars of histogram bars.

FIG. 10 illustrates an example of template-based intra mode derivation (TIMD) mode, where TIMD implicitly derives the intra prediction mode of a CU using a neighbouring template at both the encoder and decoder.

FIG. 11 illustrates a flowchart of an exemplary video coding system, where signalling of the current intra angular prediction mode depends on derived intra angular modes as derived by DIMD/TIMD according to one embodiment of the present invention.

FIG. 12 illustrates a flowchart of an exemplary video coding system that includes the DIMD derived modes in the MPM list according to one embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The following methods are proposed to improve the Intra mode derivation and prediction accuracy or coding performance:

### Remaining Mode Signalling by TIMD/DIMD

As described previously, in HEVC and VVC, an MPM list is used in order to improve the coding efficiency of the current intra prediction mode. When the current intra prediction mode is in the MPM list, the current intra prediction mode can be efficiently coded since the MPM list only contains a small number of candidates (e.g. 6). If the current intra prediction mode is not in the MPM list, the current intra prediction mode is referred as a remaining mode. In this can case, the encoder needs to signal which of the remaining modes is the current intra prediction mode. Since there are many candidates in the remaining modes, it is desirable to improve the coding efficiency when the current intra prediction mode is a remaining mode. Therefore, a method that utilises the DIMD/TIMD is disclosed to improve the signalling in the case that the current intra prediction mode is a remaining mode.

According to this method, if the current intra angular prediction mode is a remaining mode, the signalling of the current intra angular prediction mode depends on derived intra angular modes as derived by using DIMD/TIMD. In HEVC and VVC, when the current intra prediction mode is not in the MPM list, it is referred as a remaining mode. In the present invention, when the current intra prediction mode is not in the MPM (Most Probable Modes) list, or precisely predicted by other implicit intra coding tools, it is referred as a remaining mode. The present invention has extended the possible mode set to include the MPM list and a precise intra prediction mode derived using an implicit coding tool other than the DIMD and the TIMD. The key idea of using information related to the derived intra angular modes as derived by DIMD/TIMD is to narrow down or reduce the number of candidates for the remaining modes to be signalled. For example, all angular modes are initially partitioned into multiple mode groups and then, DIMD/TIMD is used to derive the most possible mode group that the current intra prediction mode belongs to. When the most possible mode group is determined, some extra coding bits (corresponding to one or more syntax, such as a mode syntax) are signalled to indicate the actual current intra angular prediction mode inside the most possible mode group. The number of candidates in the most possible mode group is expected to be much smaller than the number of the remaining modes. Therefore, the coding efficiency is improved according to the present invention.

### Including the DIMD Derived Modes in MPM List

When deriving the MPM list, one or more DIMD derived modes, one or more derived modes of DIMD derived modes or both can be included in the MPM list. In one embodiment, the MPM list includes: planar mode, one or more above neighbouring intra modes (i.e., the intra modes of above neighbouring blocks), one or more left neighbouring intra modes (i.e., the intra modes of left neighbouring blocks), one or more DIMD derived modes, one or more derived modes of neighbouring modes (e.g., neighbouring mode+k, or neighbouring mode−k), one or more derived modes of DIMD derived modes (e.g., DIMD derived mode+k, or DIMD derived mode−k), one or more defaults modes, or any combinations of them. In the above description, (neighbouring mode+k) corresponds to an intra mode with its mode number equal to ((mode number of neighbouring mode)+k) and k is a positive integer. For VVC, the mode number is from 0 to 66 and the mode numbers for other coding standards may be different.

In one embodiment, the derived modes of DIMD derived modes are included in the MPM list after including the derived mode(s) of neighbouring mode(s), or after including the above neighbouring intra mode(s) or left neighbouring intra mode(s). In still another embodiment, only the derived modes of DIMD derived mode with the tallest amplitude is included in the MPM list. In still another embodiment, only the derived mode(s) of DIMID derived mode with the i-th tallest amplitude is included in the MPM list.

### Indicating the On/Off of DIMD and TIMD Modes

Before indicating the on/off controlling syntax of DIMID and TIMID, a first syntax can be signalled to indicate if one of DIMD or TIID is allowed/enabled for the current block. For example, if the first syntax is false, DIMD or TIID is inferred not allowed/enabled for the current block. In this case, the syntax for the on/off control syntax of DIID and TIMD is not signalled. For another example, if the first syntax is true and the DIMD on/off control syntax is false, TIMD is implicitly inferred as allowed/enabled for the current block. For still another example, if the first syntax is true and the DIID on/off control syntax is true, TIID is implicitly inferred as not allowed/enabled for the current block.

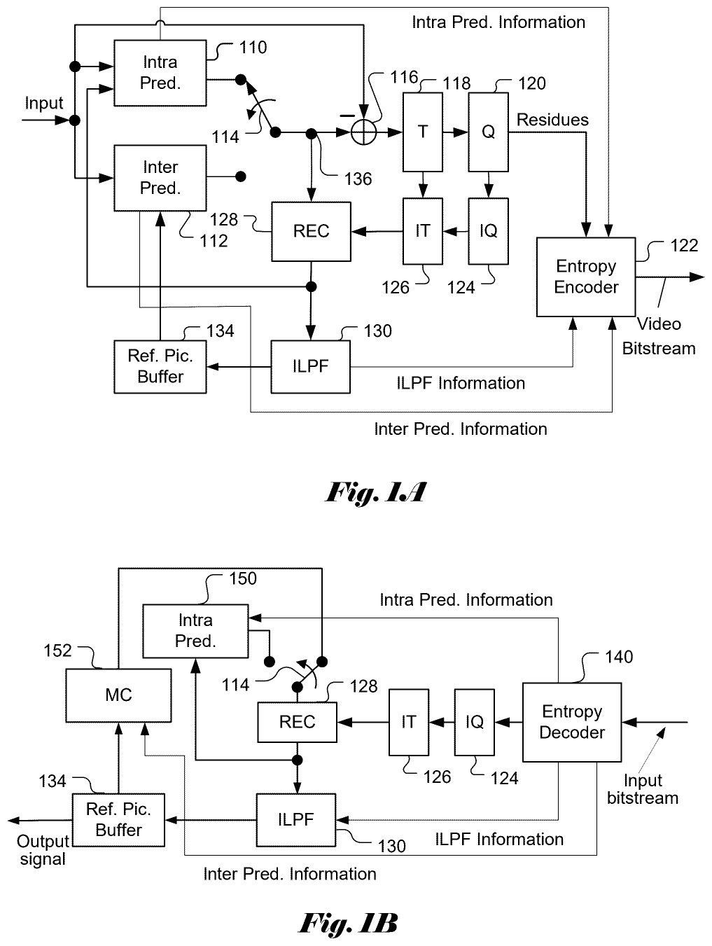

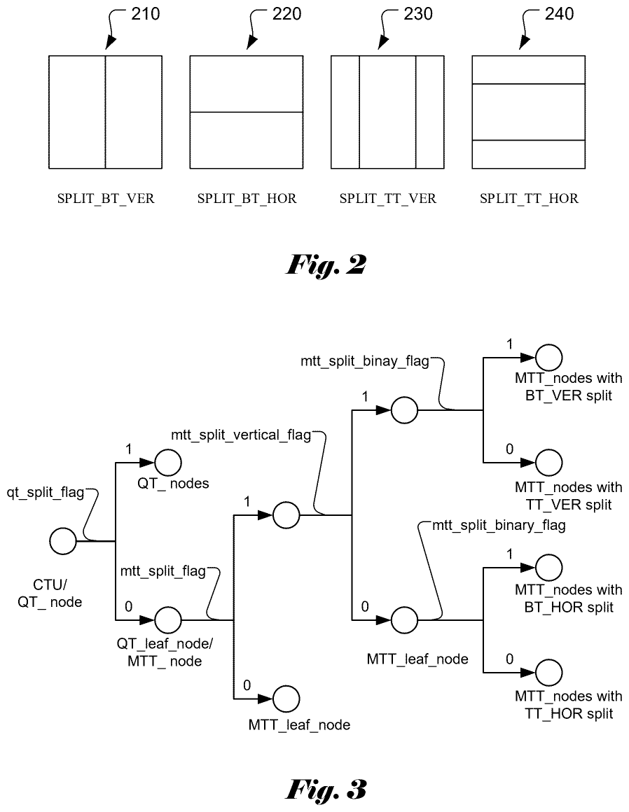

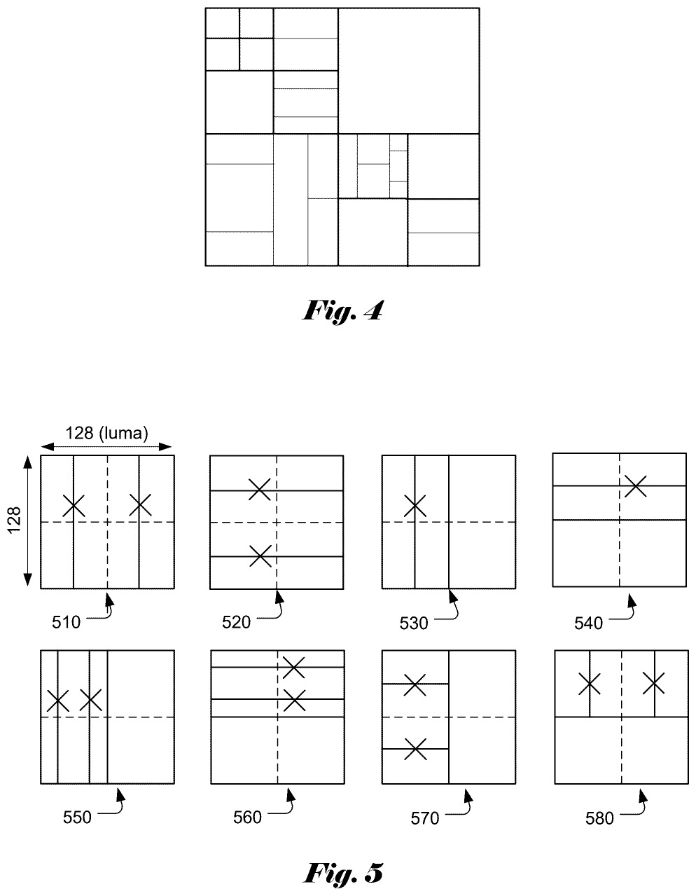

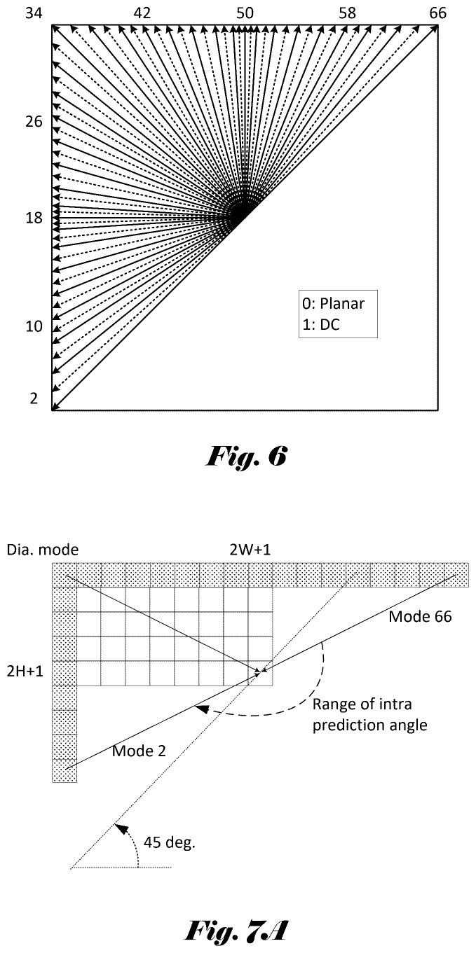

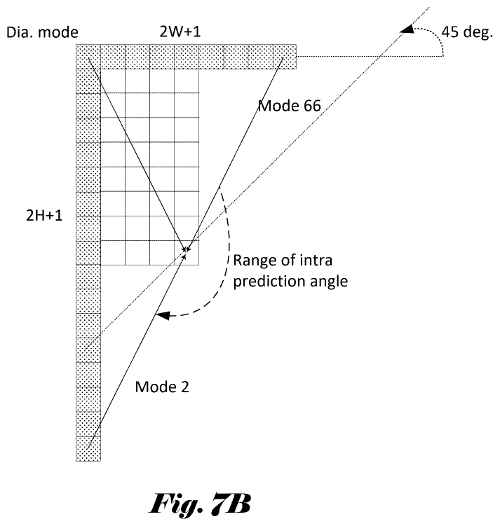

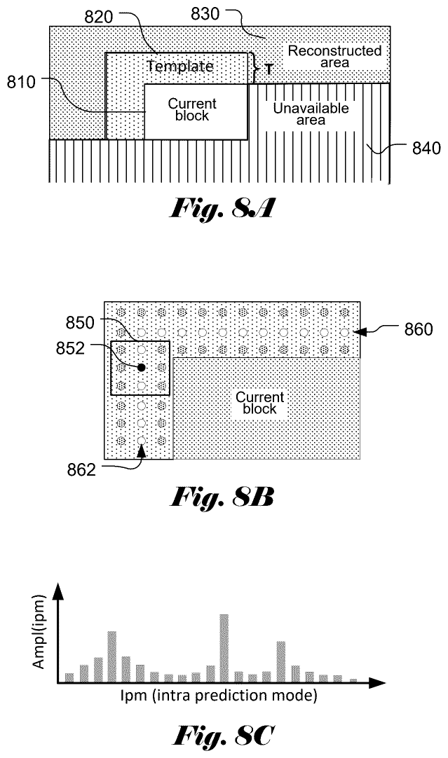

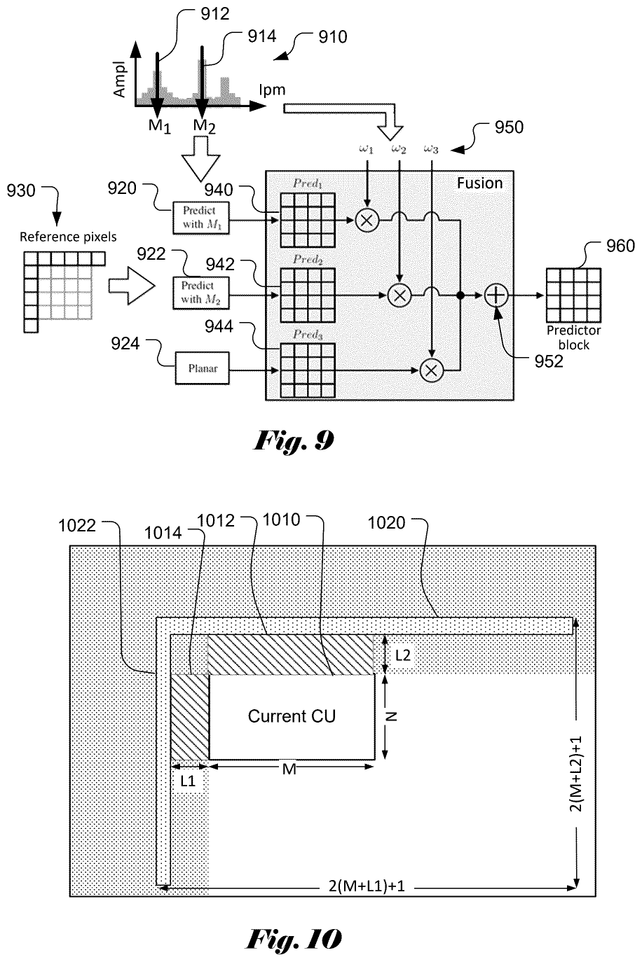

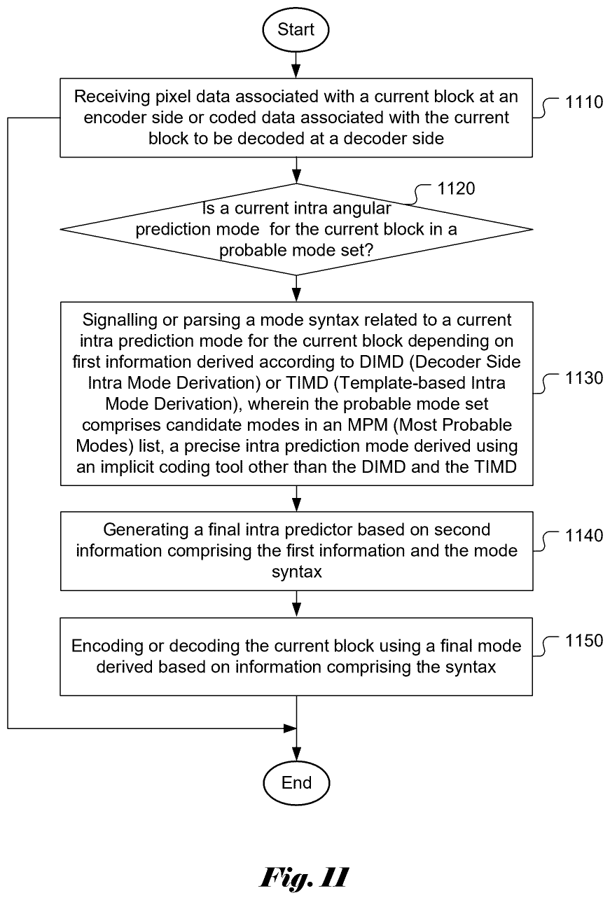

Any of the foregoing remaining mode signalling by TIMID/DIMD and including the DIMID derived modes in the MPM list methods can be implemented in encoders and/or decoders. For example, any of the proposed methods can be implemented in an intra prediction module (e.g. Intra pred. 110 in FIG. 1A) of an encoder, and/or an intra prediction module (e.g. Intra pred. 150 in FIG. 1B) of a decoder. However, the encoder or the decoder may also use additional processing units to implement the required processing. Alternatively, any of the proposed methods can be implemented as a circuit coupled to the inter/intra/prediction module of the encoder and/or the inter/intra/prediction module of the decoder, so as to provide the information needed by the inter/intra/prediction module. Furthermore, signalling related to the proposed methods may be implemented using Entropy Encoder 122 in the encoder or Entropy Decoder 140 in the decoder.

FIG. 11 illustrates a flowchart of an exemplary video coding system, where signalling of the current intra angular prediction mode depends on the derived intra angular modes as derived by DIMD/TIMD according to one embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, pixel data associated with a current block at an encoder side or coded data associated with the current block to be decoded at a decoder side are received in step 1110. Whether a current intra angular prediction mode for the current block is in a probable mode set is checked in step 1120. If the current intra angular prediction mode for the current block is not in the probable mode set (i.e., the “No” branch from step 1120), steps 1130 to 1150 are performed. Otherwise, (i.e., the “Yes” branch from step 1120), steps 1130 to 1150 are skipped. In step 1130, a mode syntax related to a current intra prediction mode for the current block is signalled or parsed depending on first information as derived according to DIMD (Decoder Side Intra Mode Derivation) or TIMD (Template-based Intra Mode Derivation), wherein the probable mode set comprises candidate modes in an MPM (Most Probable Modes) list, a precise intra prediction mode derived using an implicit coding tool other than the DIMD and the TIMD, or a combination thereof. In step 1140, a final intra predictor is generated based on second information comprising the first information and the mode syntax. In step 1150, the current block is encoded or decoded using a final mode derived based on information comprising the syntax.

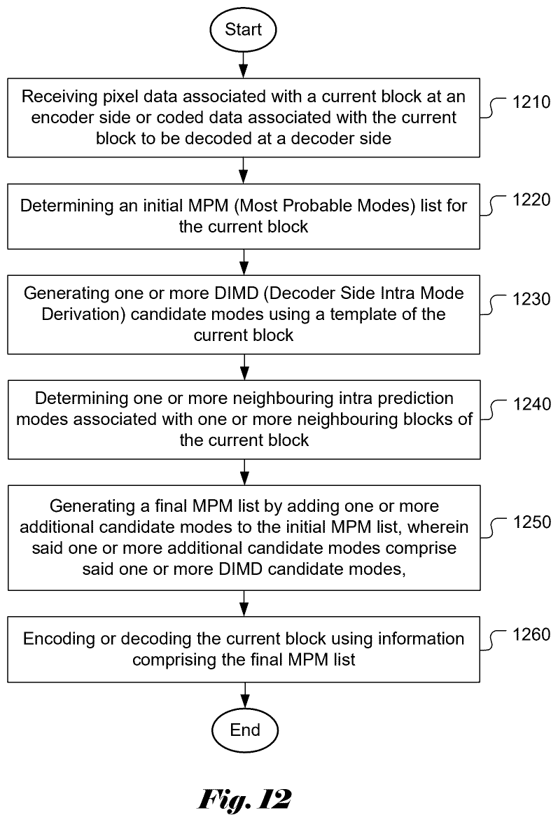

FIG. 12 illustrates a flowchart of an exemplary video coding system that includes the DIMD derived modes in the MPM list according to one embodiment of the present invention. According to this method, pixel data associated with a current block at an encoder side or coded data associated with the current block to be decoded at a decoder side are received in step 1210. An initial MPM (Most Probable Modes) list for the current block is determined in step 1220. One or more DIMD (Decoder Side Intra Mode Derivation) candidate modes are generated using a template of the current block in step 1230. One or more neighbouring intra prediction modes associated with one or more neighbouring blocks of the current block are determined in step 1240. A final MPM list is generated by adding one or more additional candidate modes to the initial MPM list in step 1250, wherein said one or more additional candidate modes comprise said one or more DIMD candidate modes, said one or more neighbouring intra prediction modes, one or more derived modes of said one or more DIMD candidate modes, one or more derived modes of said one or more neighbouring intra prediction modes, or a combination thereof. The current block encoded or decoded using information comprising the final MPM list in step 1260

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving pixel data associated with a current block at an encoder side or coded data associated with the current block to be decoded at a decoder side; and
when a current intra angular prediction mode for the current block is not in a probable mode set:
signalling or parsing a mode syntax related to a current intra prediction mode for the current block depending on first information derived according to DIMD (Decoder Side Intra Mode Derivation) or TIMD (Template-based Intra Mode Derivation), wherein the probable mode set comprises candidate modes in an MPM (Most Probable Modes) list;
generating a final intra predictor based on second information comprising the first information and the mode syntax; and
encoding or decoding the current block using a final mode derived based on information comprising the mode syntax.

2. The method of claim 1, wherein all intra angular prediction modes are divided into a plurality of groups and the first information corresponds to a target group determined for the current block based on the DIMD or the TIMD.

3. The method of claim 2, wherein the mode syntax is related to indicating the current intra angular prediction mode within the target group.

4. The method of claim 1, wherein the probable mode set comprises the candidate modes in the MPM, a precise intra prediction mode derived using an implicit coding tool other than the DIMD and the TIMD, or a combination thereof.

5. An apparatus for video coding, the apparatus comprising one or more electronics or processors arranged to:
receive pixel data associated with a current block at an encoder side or coded data associated with the current block to be decoded at a decoder side;
when a current intra angular prediction mode for the current block is not in a probable mode set:
signal or parse a mode syntax related to a current intra prediction mode for the current block depending on first information derived according to DIMD (Decoder Side Intra Mode Derivation) or TIMD (Template-based Intra Mode Derivation), wherein the probable mode set comprises candidate modes in an MPM (Most Probable Modes) list;
generate a final intra predictor based on second information comprising the first information and the mode syntax; and
encode or decode the current block using a final mode derived based on information comprising the mode syntax.

6. A method of video coding, the method comprising:
receiving pixel data associated with a current block at an encoder side or coded data associated with the current block to be decoded at a decoder side;
determining an initial MPM (Most Probable Modes) list for the current block;
generating one or more DIMD (Decoder Side Intra Mode Derivation) candidate modes using a template of the current block;
determining one or more neighbouring intra prediction modes associated with one or more neighbouring blocks of the current block;
generating a final MPM list by adding one or more additional candidate modes to the initial MPM list, wherein said one or more additional candidate modes comprise said one or more DIMD candidate modes; and
encoding or decoding the current block by using information comprising the final MPM list.

7. The method of claim 6, wherein said one or more additional candidate modes comprise said one or more DIMD candidate modes, said one or more neighbouring intra prediction modes, one or more derived modes of said one or more DIMD candidate modes, one or more derived modes of said one or more neighbouring intra prediction modes, or a combination thereof.

8. The method of claim 7, wherein said one or more derived modes of said one or more DIMD candidate modes comprise a mode number corresponding to (one DIMD candidate mode+k), wherein the k is a non-zero integer.

9. The method of claim 7, wherein said one or more derived modes of said one or more neighbouring intra prediction modes comprise a mode number corresponding to (one neighbouring intra prediction mode+k), wherein the k is a non-zero integer.

10. The method of claim 7, wherein said one or more neighbouring intra prediction modes comprise an above neighbouring intra prediction mode of an above neighbouring block, a top neighbouring intra prediction mode of a top neighbouring block, or both.

11. The method of claim 7, wherein said one or more derived modes of said one or more DIMD candidate modes are including in the final MPM list after said one or more derived modes of said one or more neighbouring intra prediction modes or after said one or more neighbouring intra prediction modes.

12. An apparatus for video coding, the apparatus comprising one or more electronics or processors arranged to:
receive pixel data associated with a current block at an encoder side or coded data associated with the current block to be decoded at a decoder side;
determine an initial MPM (Most Probable Modes) list for the current block;
generate one or more DIMD (Decoder Side Intra Mode Derivation) candidate modes using a template of the current block;
determine one or more neighbouring intra prediction modes associated with one or more neighbouring blocks of the current block;
generate a final MPM list by adding one or more additional candidate modes to the initial MPM list, wherein said one or more additional candidate modes comprise said one or more DIMD candidate modes, said one or more neighbouring intra prediction modes, one or more derived modes of said one or more DIMD candidate modes, one or more derived modes of said one or more neighbouring intra prediction modes, or a combination thereof, and
encode or decode the current block by using information comprising the final MPM list.
